(19) United States
(12) Patent Application Publication
(10) Pub. No.: US 2003/0174063 A1
(43) Pub. Date: Sep. 18, 2003

(54) Auto initialization of the zero-reference weight in occupant weight estimation system

(76) Inventors: Otman A. Basir, Kitchener (CA); Fakhreddine Karray, Waterloo (CA); Brian Johnson, Waterloo (CA)

Correspondence Address: CARLSON, GASKEY & OLDS, P.C., 400 WEST MAPLE ROAD, SUITE 350, BIRMINGHAM, MI, 48009, US

(21) Appl. No.: 10/387,726

(22) Filed: Mar. 13, 2003

Related U.S. Application Data
(60) Provisional application No. 60/363,917, filed on Mar. 13, 2002.

(51) Int. Cl. G08B 21/00

(52) U.S. Cl. 340/667; 340/425.5; 73/1.01

(57) ABSTRACT

A vehicle seat weight calibration includes at least one weight sensor for determining weight on a seating surface and at least one presence sensor for determining the presence of an occupant on the seating surface. The at least one weight sensor is calibrated based upon a determination by the presence sensor that an occupant is not present on the seating surface. If it is determined that no occupant is present on the seating surface, and if the current weight indication from the weight sensor is within a predetermined value of a previously stored zero-reference weight, the current weight is stored as the new zero-reference weight.

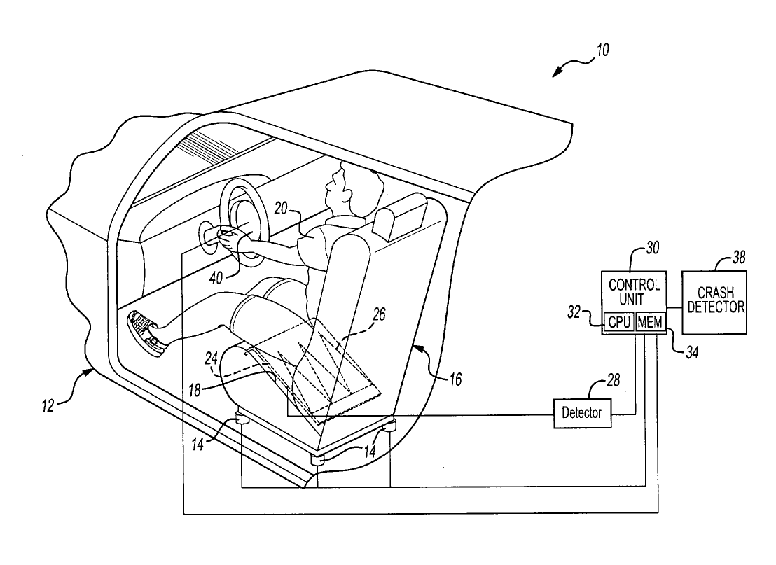

This application claims priority to U.S. Provisional patent application Serial No. 60/363,917, filed Mar. 13, 2002.

### BACKGROUND OF THE INVENTION

Many vehicle occupant safety systems include sensors for determining the weight of the occupant. Based upon the weight of the occupant, the vehicle occupant safety system determines whether to activate active safety restraints, such as airbags. The vehicle occupant safety system may also determine the amount of force with which to deploy the active safety restraints based upon the weight of the occupant. For example, if the weight of the occupant is determined to be below a minimum, the vehicle occupant safety system may determine not to activate the active safety restraint in the event of a crash. If the weight of the occupant is determined to be above the minimum threshold, but below a second threshold, the vehicle occupant safety system may determine to activate the active safety restraints at a first level of deployment in the event of a crash. If the vehicle occupant safety system determines that the occupant weight exceeds the second threshold, the vehicle occupant safety system may determine to activate the active restraint systems at a second level higher than the first level in the event of a crash.

Some of these systems attempt to calibrate the weight sensors. However, the systems generally solely rely on the weight values observed by the weight sensors to calibrate themselves.

### SUMMARY OF THE INVENTION

The present invention provides a vehicle seat weight calibration system including at least one weight sensor for determining the weight on a seating surface and at least one presence sensor for determining the presence of the occupant on the seating surface. In the present invention, the weight sensor is only calibrated after a determination by the presence sensor that an occupant is not present on the seating surface. If the presence sensor determines that an occupant is present on the seating surface, calibration of the weight sensor is inhibited.

If the presence sensor determines that an occupant is not present on the seating surface, a controller evaluates the weight signal from the weight sensor and compares it to a previously stored zero-reference weight. If the current weight as indicated by the at least one sensor is within a pre-determined value of the previously stored zero-reference weight, the current weight signal is stored as the zero-reference weight.

In a preferred embodiment, the presence sensor may comprise a capacitive sensor mounted in the seat for measuring a capacitance on the seat. The weight sensors may comprise a plurality of load cells mounted between the seat and the vehicle compartment floor.

### BRIEF DESCRIPTION OF THE DRAWINGS

The FIGURE illustrates the vehicle seat weight calibration system of the present invention.

### DETAILED DESCRIPTION OF THE PREFERRED EMBODIMENT

A vehicle seat weight calibration system 10 according to the present invention is shown schematically in the FIGURE. The system 10 is installed in a vehicle 12. The system 10 includes a plurality of weight sensors 14 mounted on the bottom of a vehicle seat 16 for determining a weight upon a seating surface 18, in particular, the weight of an occupant 20. The weight sensors 14 are preferably installed between the vehicle seat 16 and the floor of the vehicle 12; however, the sensors 14 could be located elsewhere. The weight sensors 14 preferably comprise load cells and may comprise the load cells disclosed in co-pending application U.S. Ser. No. 10/372,007, filed Feb. 21, 2003, and entitled “Load Cell,” which is commonly assigned and which is hereby incorporated by reference in its entirety.

The system 10 further includes at least one presence sensor 24 which may comprise a capacitive sensor 24, such as is described in co-pending U.S. Ser. No. 10/319,431, filed Dec. 13, 2002, entitled “Occupant Presence Detection Device,” which is commonly assigned and which is hereby incorporated by reference in its entirety. Generally, the presence sensor 24 may include an electrode 26, such as conductive thread sewn into material in the vehicle seat 16, or a conductive plate. The electrode 26 is connected to a detection circuit 28 which measures capacitance at the electrode 26, and in particular the capacitance on the seating surface seat 16. When the occupant 20 is present on the seating surface 18 of the vehicle seat 16, this changes the capacitance measured by electrode 26, as detected by detection circuit 28, which then determines that the occupant 20 is present on the seating surface 18 of the vehicle seat 16.

The system 10 further includes a control unit 30 including a CPU 32 and computer readable medium, such as memory 34, hard-drive, optical media, magnetic media or other electronic storage. The memory 34 contains a computer program suitably programmed to perform the functions described herein.

The system 10 further includes a crash detector 38 and an active safety restraint, such as an airbag 40. The control unit 30 receives signals from the weight sensors 14, the presence sensor 24 and the crash detector 38 and, based upon this information, determines whether or not to activate the airbag 40, and the force level with which to activate the airbag 40.

Utilizing any of various known techniques, algorithms and rules, the control unit 30 determines the presence of the occupant based upon presence sensor 24 and determines the weight of the occupant utilizing weight sensors 14. Based upon the weight and the presence of the occupant, and the severity of the crash as determined by crash detector 38, the control unit 30 determines whether to activate airbag 40 and the level of force with which to activate airbag 40.

The present invention provides a system and method for initializing and calibrating the weight sensors 14. Generally, each of the weight sensors 14 must each have associated with it a zero-reference weight. Each weight sensor 14 senses the weight of the seat itself 16, any force exerted by any fasteners fastening the seat 16 to the floor of the vehicle 12, and any preloaded force in the sensor 14. A zero-reference weight representing the sum of these weights must be associated with each sensor 14. The zero-reference weight is the value output by the weight sensor 14 when there is no occupant or weight on the vehicle seat 16. The weight of the occupant 20 is then determined by comparing the current value from the weight sensor 14 to the stored zero-reference weight. The zero-reference weight could change over time, as the sensors 14 wear or as the weight of the seat 16 changes.

The initial zeroing of the weight inputs to the system 10 is after the seat 16 is completely installed in the vehicle 12. Having the seat 16 installed allows for the final tightening of all the fasteners, which could affect the zero readings of the sensors 14. The initial calibration at this stage could be formed in a quick a non-intrusive manner to the system 10 in a controlled environment. With the seat 16 completely empty and in a particular seat position, the control unit 30 is notified that the seat is empty and ready for re-zeroing. Upon receiving the signal, the control unit 30 will read all the inputs from the weight sensors 14 (the zero weight values) and store the values to the re-writable, non-volatile media, such as the memory 34. Throughout the life of the vehicle 12, the zero weight values will be updated automatically by the system 10 and the new zero values will be written to memory 34. The system 10 will also communicate a re-zeroing success signal to a diagnostic device, and this initial step for re-zeroing will not have to be done in the future by such a method, since it will be performed intelligently by the weight system 10.

Since the zero-reference weight values are stored in a non-volatile memory 34, they are readily available to the occupant weight estimation program in control unit 30. Each time the weight system is restarted, the zero values in memory are compared with an average of a fixed number of current weight readings from the sensors 14. If only a slight deviation exists (e.g. 500 gram offset on a couple weight sensors 14) then these new average weight values for each sensor 14 will be written to the memory associated with each weight sensor 14 and these values will be used from that time on. If the weight sensors 14 are producing values much different from those stored in memory 34, then the system 10 uses the stored zero-reference values, since something is on the seat and its weight is determined by the weight estimation system. The system 10 re-calibrates to the zero weight values at the time of startup or when an occupant 20 has left the seat 16.

This method of re-zeroing does not solely rely on the weight values observed by the weight sensors 14. It also uses the presence sensor 24 to determine if an occupant 20 is present on the seat 16. If a human is on the seat 16, a presence sensor 24 will detect a change in capacitance and the detection circuit 28 will produce a high signal. If the seat 16 is empty, or have an object without human characteristics (capacitance) is on the seat 16, then the detection circuit 28 will produce a load signal.

The presence sensor 24 allows for the re-zeroing of the weight sensors 14 sometime after the occupant 20 has left the seat 16. Almost immediately after the presence sensor 24 detects the change in capacitance, the detector circuit 28 produces a low signal indicative of the occupant 20 leaving the seat 16. After a few seconds, the system 10 may re-zero itself if the weight values from the weight sensors 14 have stabilized (i.e. are not oscillating from the occupant leaving the seat 16) and if the weight sensors 14 are very close to the current zero-weight values (e.g. a maximum 500 gram offset on different weight sensors 14). This allows the system to only re-calibrate after an occupant 20 has left the seat and only if the seat 16 is indeed empty so that if the occupant 20 were to have left a weight sitting on the seat 16 as he or she exited the vehicle 12, the system 10 would recognize that weight and would not recalibrate the zero-weight values, since the seat 16 is not empty.

The allowable weight sensor zero value offset is greatly dependent on the type of sensors 14 used and the performance of the sensor 14 when it immediately becomes empty. The time duration allowed between the seat 16 becoming empty and considering recalibrating the zero weight values is also dependent upon these performance characteristics.

The empty weight sensor offsets (due to the weight of the seat pan, cushion and fastening hardware) are deducted from the gross weight provided by the weight sensors to obtain the net weight applied by the occupant 20. Although load cells and capacitive sensors have been disclosed as the weight sensor 14 and presence sensor 24 of the present invention, other types of sensors could also be utilized.

What is claimed is:

1. A vehicle seat weight calibration system comprising:
at least one weight sensor for determining weight on a seating surface;
at least one presence sensor for determining the presence of an occupant on the seating surface; and
a controller calibrating the at least one weight sensor based upon a determination by the at least one presence sensor that an occupant is not present on the seating surface.

2. The vehicle seat weight calibration system of claim 1 wherein the at least one presence sensor includes at least one capacitive sensor.

3. The vehicle seat weight calibration system of claim 2 wherein the controller calibrates a zero-reference weight of the at least one sensor based upon the determination by the at least one presence sensor that an occupant is not present on the seating surface.

4. The vehicle seat weight calibration system of claim 3 wherein the at least one weight sensor includes a plurality of load cells.

5. The vehicle seat weight calibration system of claim 4 wherein the at least one presence sensor is mounted between the seating surface and the at least one weight sensor.

6. The vehicle seat weight calibration system of claim 3 wherein the controller calibrates the zero-reference weight of the at least one sensor based upon a comparison of a current weight from the at least one sensor to a previously-stored zero-reference weight.

7. The vehicle seat weight calibration system of claim 6 wherein the controller calibrates the zero-reference weight of the at least one sensor only if the current weight is within a predetermined threshold of the previously-stored zero-reference weight.

8. A method for calibrating a vehicle seat weight system including the steps of:
a) determining weight on a seating surface;
b) determining the presence of an occupant on the seating surface; and
c) calibrating the vehicle seat weight system based upon a determination that an occupant is not present on the seating surface.

9. The method of claim 8 wherein step b) further includes the step of measuring a capacitance on the seating surface.

10. The method of claim 9 wherein said step c) further includes the step of calibrating a zero-reference weight based upon a determination in said step b) that an occupant is not present on the seating surface.

11. The method of claim 10 wherein the vehicle seat weight system includes a plurality of load cells.

12. The method of claim 8 wherein said step c) further includes the step of calibrating the zero-reference weight based upon a comparison of a current weight determined in said step a) to a previously-stored zero-reference weight.

13. The method of claim 12 wherein said step c) further include the step of calibrating the zero-reference weight only if the current weight is within a predetermined threshold of the previously-stored zero-reference weight.

14. A computer-readable medium storing a computer program which when executed by a computer performs the steps of:
a) receiving an indication of a weight on a seating surface from a vehicle seat weight system;
b) determining whether an occupant is present on the seating surface; and
c) calibrating the vehicle seat weight system based upon a determination that an occupant is not present on the seating surface.

15. The computer-readable medium of claim 14 wherein said step c) further includes the step of calibrating the zero-reference weight based upon a comparison of a current weight determined in said step a) to a previously-stored zero-reference weight.

16. The method of claim 15 wherein said step c) further include the step of calibrating the zero-reference weight only if the current weight is within a predetermined threshold of the previously-stored zero-reference weight.
